(19) United States
(12) Patent Application Publication
(10) Pub. No.: US 2013/0275256 A1
(43) Pub. Date: Oct. 17, 2013

(54) System and Method for Ordering Promotional Products

(71) Applicant: BOOST TECHNOLOGIES, LLC, Dayton, OH (US)

(72) Inventor: Michael J. Emoff, Dayton, OH (US)

(73) Assignee: Boost Technologies, LLC, Dayton, OH (US)

(21) Appl. No.: 13/854,362

(22) Filed: Apr. 1, 2013

Related U.S. Application Data
(60) Provisional application No. 61/625,162, filed on Apr. 17, 2012.

(51) Int. Cl. G06Q 30/06

(52) U.S. Cl. CPC G06Q 30/0635
USPC 705/26.5; 705/26.8; 705/26.81

(57) ABSTRACT

A method for offering products to a consumer, the method including the steps of (1) assembling a catalog including at least a first product and a second product, the first product having a first default indicia and the second product having a second default indicia, (2) preparing a first sample of the first product and a second sample of the second product, (3) associating a first reference number with the first sample and a second reference number with the second sample, (4) associating the first reference number with the first product and the second reference number with the second product, (5) presenting the catalog to the consumer with an invitation to order at least one of the products, and (6) receiving an order from the consumer, the order specifying at least one of the reference numbers.

### PRIORITY

This application claims priority from U.S. Ser. No. 61/625,162 filed on Apr. 17, 2012, the entire contents of which are incorporated herein by reference.

### FIELD

The present disclosure generally relates to sales of promotional products. More particularly, the present disclosure relates to systems and methods that allow for simplified ordering and/or reordering of promotional products.

### BACKGROUND

Current processes for ordering promotional products, such as products that may be customized by a consumer with text, graphics and the like, currently involve a number of tedious steps for ordering. For example, a consumer may place an order to a promotional products company. The order may be in a first format that includes information regarding the order. As one example, the first format may be set by the customer. As another example, the first format may be set by the promotional products company. The promotional products company must then convert the first format to a second format that may be used by a supplier to manufacture the products. For example, the promotional products company may provide a large quantity of details regarding the ordered product to the supplier, such as type, size, color, indicia on the product and/or the like. The supplier may then manufacture the products in accordance with the information obtained.

Because the promotional products company must convert the details of each order from a first format received from the consumer to a second format that is recognizable by the supplier, an excessive amount of resources, such as computing power, manpower, time, expenses and the like, are required. Furthermore, the current need to convert order information into the correct format for the supplier makes it difficult to automate the process of ordering promotional products.

Accordingly, there exists a need for systems and methods to obtain customized orders from a consumer and place the order with a supplier that is less time consuming, less costly, less taxing on resources and/or the like.

### SUMMARY

In one aspect, disclosed is a method for offering products to a consumer, the method may include the steps of (1) assembling a catalog including at least a first product and a second product, the first product having a first default indicia and the second product having a second default indicia, (2) preparing a first sample of the first product and a second sample of the second product, (3) associating a first reference number with the first sample and a second reference number with the second sample, (4) associating the first reference number with the first product and the second reference number with the second product, (5) presenting the catalog to the consumer with an invitation to order at least one of the products, and (6) receiving an order from the consumer, the order specifying at least one of the reference numbers.

In another aspect, disclosed is a system for offering products to a consumer. The system may include (1) a catalog including at least a first product and a second product, the first product having a first default indicia and a first reference number, the second product having a second default indicia and a second reference number, (2) a supplier, wherein the supplier has produced the first product and the second product, and wherein the supplier has associated the first produced product with the first reference number and the second produced product with the second reference number, and (3) a promotional products company in communication with the consumer and the supplier, wherein the promotional products company presents the catalog to the consumer and receives order information from the consumer, and wherein the promotional products company communicates the order information to the supplier, the order information including at least one of the first and second reference numbers.

Other aspects of the disclosed system and method for ordering promotional products will become apparent from the following detailed description, the accompanying drawings and the appended claims.

### BRIEF DESCRIPTION OF THE DRAWINGS

FIG. 1 depicts a block diagram of a promotional product ordering relationship in accordance with an embodiment of the disclosure.

FIG. 2 depicts an exemplary promotional product in accordance with an embodiment of the disclosure.

FIG. 3 depicts an exemplary catalog of promotional products in accordance with an embodiment of the disclosure.

FIG. 4 depicts a flow diagram of a process of receiving an order from a consumer and transmitting the order to a supplier in accordance with an embodiment.

### DETAILED DESCRIPTION

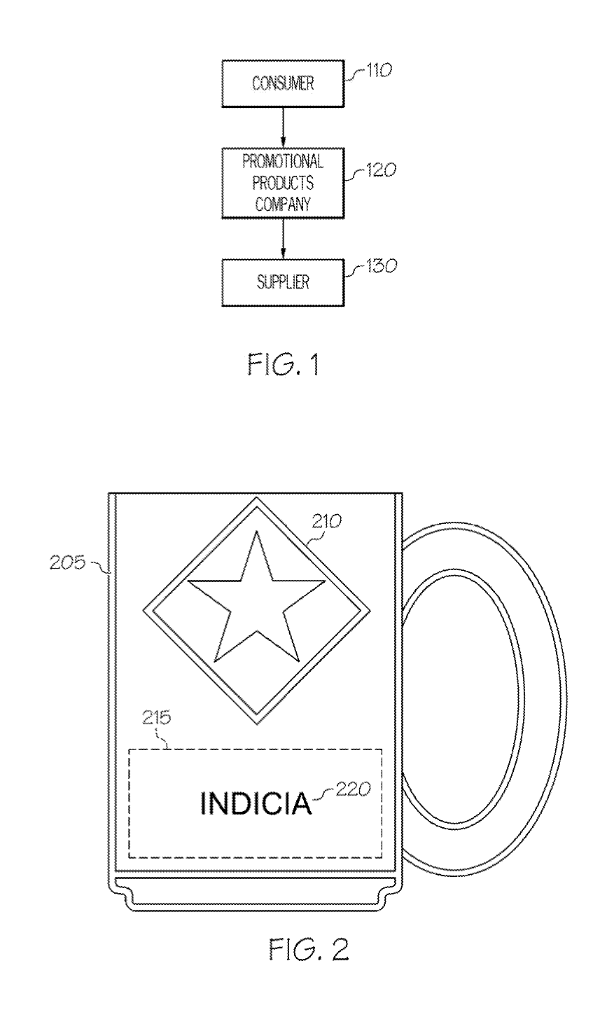

Disclosed are systems and methods for ordering promotional products. As shown in FIG. 1, a consumer 110 may communicate with a promotional products company 120 for the purposes of inquiring, placing an order, placing a re-order and/or the like. The promotional products company 120 may then communicate with one or more suppliers 130 to order products for the consumer 110.

A consumer 110 may be any entity, such as an individual, a corporation, a non-profit group, a division, an association or the like that wishes to purchase and/or customize one or more promotional products. The promotional products company 120 may be any entity, such as an individual, corporation or the like, that distributes promotional products to consumers 110. The supplier 130 may be any entity that manufactures and/or decorates promotional products or otherwise supplies promotional products to the promotional products company 120 for distribution to the consumer 110. The supplier 130 further may be a separate entity from the promotional products company 120, may be a subsidiary of the promotional products company 120, a division of the promotional products company 120 or the like.

Communication between the consumer 110 and the promotional products company 120 may occur by any type of communications method now known or later developed. Examples of such communications methods may include telephony communications, facsimile communications, internet-based communications and the like. Communications may further include consumer 110 interactions with a representative or agent of the promotional products company 120, or may not involve person-to-person interaction, such as instances where the consumer 110 may fill out a web-based or fax-based automated form that is automatically logged into a database maintained by the promotional products company 120 or instances where a consumer 110 may employ an automatic reordering system that communicates directly with a system at the promotional products company 120 at specified intervals, such as when a consumer's supply of promotional products reaches a low threshold.

FIG. 2 depicts an exemplary promotional product 205 in accordance with an embodiment. The promotional product may optionally include one or more default indicia 210 and/or one or more pre-defined fields 215.

While the promotional product 205 is shown and described as a branded product, specifically a branded coffee mug, those skilled in the art will appreciate that various articles of manufacture, whether branded or not, may be promotional products 205 without departing from the scope of the present disclosure. Examples of other promotional products may include, but are not limited to, articles of clothing, office supplies, paper products such as calendars, business cards, blank sheets with embossed personalization or the like, beverage containers, buttons, badges, toys, signs, displays and/or the like. Furthermore, promotional products may vary based on color, size, dimensions and/or the like.

The promotional products company and the supplier may provide multiple different promotional products 205. Thus, differing promotional products of the same type (but with varying types of indicia 210 and/or pre-defined fields 215) or different types of promotional products (which may further contain similar or differing indicia 210 and/or pre-defined fields 215) may be provided by the supplier and/or the promotional products company. Each differing iteration of a promotional product 205 with a differing indicia 210 and/or pre-defined field 215 may have a unique reference number, as described in more detail herein.

The promotional product 205 may optionally contain one or more default indicia 210 such as a picture, logo, icon, text and/or the like that is imprinted on every promotional product placed by the consumer. The one or more default indicia 210 may generally be located at any position on the promotional product, and may be etched, painted, drawn, stamped, written and/or the like depending on the type of promotional product and/or a preference of the supplier or the promotional products company.

The default indicia 210, if it is provided on a particular product, may not be modified, moved, replaced, deleted, supplemented and/or the like in any manner by the consumer. Thus, the default indicia 210 may remain the same on every promotional product 205. A product containing default indicia 210 may be viewed as one of the multiple iterations of a product, similar to products of different colors, sizes and the like. Thus, products with differing default indicia 210 may have differing reference numbers, as described in greater detail herein.

The promotional product 205 may optionally contain one or more pre-defined fields 215 that contain customizable indicia 220 such as pictures, logos, icons, text and/or the like that may vary in each iteration of the promotional product 205 ordered by a consumer, or may remain consistent for each promotional product 205 ordered by the consumer. For example, a consumer may order 25 promotional products 205 that all contain the same customizable indicia 220, such as an inspirational quote, or alternatively may order 25 promotional products 205 that each contain different customizable indicia 220, such as a different name on each promotional product 205. The one or more pre-defined fields 215 may generally be located at any position on the promotional product, and may be etched, painted, drawn, stamped, written and/or the like depending on the type of promotional product and/or a preference of the supplier or the promotional products company.

While the consumer may specify or modify the customizable indicia 220 within the pre-defined fields 215, the location of the pre-defined fields 215 on the promotional product 205 may be at a pre-set location, and may not be moved by the consumer. Furthermore, the type of customizable indicia 220 that the consumer may specify or modify within the pre-defined fields 215 may be limited to a certain type, such as, for example, only text of a certain font, only pictures of a certain size or color, and/or the like.

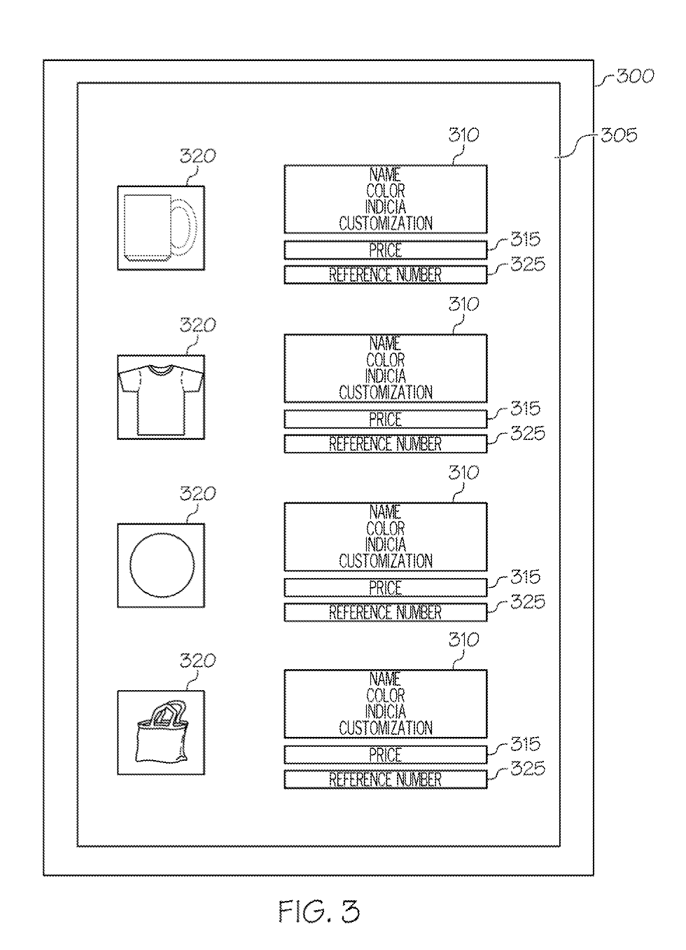

As shown in FIG. 3, the promotional products company may provide a catalog 300 containing a list of promotional products 305 that are offered for sale to the consumer. The catalog 300 may be, for example, a paper catalog, such as a catalog that is mailed to consumers, an online list of products such as a web-based store, or contained within a software application for viewing on an electronic device such as a kiosk, a computer, a smartphone, a tablet and the like. As an alternative to a catalog 300, the promotional products company may provide physical samples of each promotional product available for purchase, such as, for example, a physical product display at a trade show or a retail store display.

The list of promotional products 305 may contain information 310 about each of the products 205 (FIG. 2) that are available from the promotional products company. Information 310 may be, for example, the name of the product, various color options for the product, various indicia options for the product, various customization options for the product, various sizes and/or the like. The list of promotional products 305 may further contain a price 315 for each promotional product, one or more images 320 of a promotional product and a reference number 325 for each promotional product.

The reference number 325 may generally be any type of identifier, such as a stock-keeping unit (SKU) number, serial number, order number, electronic product code (EPC), part number and/or the like. The reference number 325 may be any combination of letters, numbers, images and/or symbology such as bar codes, QR codes and the like.

The reference number 325 may vary for each iteration of a promotional product. For example, a promotional product that is offered in a plurality of different colors may have a reference number 325 for each different color available. Likewise, a promotional product that is offered in a plurality of different sizes may also have a reference number 325 for each size available. Thus, a promotional product that is size large and blue in color may have a different reference number 325 than that of a product that is size large and yellow in color. Furthermore, promotional products that may have the same characteristics (i.e., size and color) but different default indicia 205 (FIG. 2) may also contain differing reference numbers 325.

Since each iteration of a promotional product has a different reference number 325, the promotional products company and the supplier may identify a precise set of parameters for a promotional product by its reference number 325. Thus, if a promotional products company has specified that a large mug that is blue in color and contains a default indicia 205 above a pre-defined field 215 (for inputting customizable indicia 220 when specified) has a reference number 325 of XXX1234, the supplier may receive the reference number of XXX1234 and know to produce the same large mug that is blue in color and contains the default indicia 205 above the customizable indicia 215 (if any) without any further direction or input from the promotional products company.

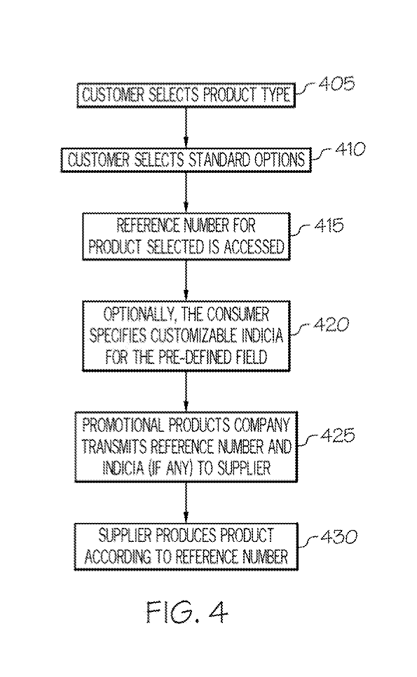

A workflow of an exemplary promotional product ordering process is depicted in FIG. 4. First, the consumer may select a product type 405 and default options that are offered by the promotional products company and the supplier 410 such as color, size and default indicia. The promotional products company notes the reference number for the selected product 415 and may optionally provide the consumer with the ability to add customizable indicia 220 (FIG. 2) within the pre-defined field 215 (FIG. 2) of the product 420. The promotional products company may then provide the reference number, as well as the customizable indicia (if any) to the supplier 425. Other information, such as a number of products, shipping information, and the like may also be provided at this time. The supplier then produces the proper product based upon the reference number provided by the promotional products supplier 430. If the product contains an area for the optional customizable indicia, the supplier may produce the product with the indicia at that time.

Referring back to FIGS. 1 and 3, prior to the promotional products company 120 offering the products 320 in the catalog 300 to the consumer 110, the promotional products company 120 may coordinate with the supplier 130 to produce at least one physical sample of each product 320 in the catalog 300 and assign a reference number 325 to each product 320 in the catalog 300. Therefore, the promotional products company 120 may inspect the quality of each product 320 in the catalog 300 prior to offering the products 320 to the consumer 110. Furthermore, the reference number 325 will provide the supplier 130 with the information necessary to produce additional products 320 (except customization in the pre-defined field 215) prior to the products 320 being offered to the consumer 110.

Optionally, rather than producing a physical sample of each product, a virtual representation of a product 320 may be produced, such as by graphical rendering, CAD drawing or the like. The reference number 325 may then be assigned to the product 320 based on the virtual representation prepared by the supplier 130.

Thus, each product 320 will have been produced at least once (physically or virtually) prior to being offered in the catalog 300. Therefore, a consumer 110 may place an order for a particular product 320 simply by specifying the reference number 325 for that product, as well as any customization within the pre-defined field 215 (FIG. 2), and the promotional products company 120 need only forward the information (e.g., reference number, quantity and customization in the pre-defined field) along to the supplier 130. As such, each order from the consumer 110 may be treated as a re-order, thereby significantly simplifying the process (e.g., no reformatting of order information may be required).

Accordingly, by coordinating with the supplier 130 to pre-design the products 320 in the catalog 300 such that each product 320 has a reference number assigned thereto before being offered to the consumer 110, the promotional products company 120 may significantly streamline the process for ordering promotional products, while still allowing basic customization within the pre-defined field 215. Therefore, the streamlined process for ordering promotional products may be automated, such as by way of an online website interface between the consumer 110 and the promotional products company 120, and electronic communication between the promotional products company 120 and the supplier 130.

Although various aspects of the disclosed point of sale device have been shown and described, modifications may occur to those skilled in the art upon reading the specification. The present application includes such modifications and is limited only by the scope of the claims.

What is claimed is:

1. A method for offering products to a consumer, said method comprising the steps of:
assembling a catalog comprising at least a first product and a second product, said first product comprising a first default indicia and said second product comprising a second default indicia;
preparing a first sample of said first product and a second sample of said second product;
associating a first reference number with said first sample and a second reference number with said second sample;
associating said first reference number with said first product and said second reference number with said second product;
presenting said catalog to said consumer with an invitation to order at least one of said first product and said second product; and
receiving an order from said consumer, said order specifying at least one of said first reference number and said second reference number.

2. The method of claim 1 further comprising the step of forwarding said order to a supplier.

3. The method of claim 2 wherein said supplier performs said preparing step.

4. The method of claim 3 wherein said supplier fulfills said order based on said at least one of said first reference number and said second reference number specified in said order and a quantity indication specified in said order.

5. The method of claim 1 further comprising the step of producing product based on said at least one of said first reference number and said second reference number specified in said order.

6. The method of claim 1 wherein said first sample is one of a physical sample and a virtual sample.

7. The method of claim 1 wherein said second sample is one of a physical sample and a virtual sample.

8. The method of claim 1 wherein said step of preparing said first and said second samples is performed prior to said presenting step.

9. The method of claim 1 wherein said first product comprises a first pre-defined field and said second product comprises a second pre-defined field.

10. The method of claim 9 wherein said order specifies customization within at least one of said first pre-defined field and said second pre-defined field.

11. The method of claim 10 wherein said customization is text-only customization.

12. The method of claim 1 wherein said presenting step is performed over the Internet.

13. The method of claim 1 wherein said presenting step is by a webpage.

14. A system for offering products to a consumer, said system comprising:
a catalog comprising at least a first product and a second product, said first product comprising a first default indicia and a first reference number, said second product comprising a second default indicia and a second reference number;
a supplier, wherein said supplier has produced a first sample of said first product and a second sample of said second product, and wherein said supplier has associated said first sample with said first reference number and said second sample with said second reference number;
a promotional products company in communication with said consumer and said supplier, wherein said promotional products company presents said catalog to said consumer and receives order information from said consumer, and wherein said promotional products company communicates said order information to said supplier, said order information comprising at least one of said first and said second reference number.

15. The system of claim 14 wherein said first sample is one of a physical sample and a virtual sample.

16. The system of claim 14 wherein said second sample is one of a physical sample and a virtual.

17. The system of claim 14 wherein said first product comprises a first pre-defined field and said second product comprises a second pre-defined field.

18. The system of claim 17 wherein said order information comprises customization information for at least one of said first and said second pre-defined fields.

19. The system of claim 18 wherein said customization information comprises text.
